(19) United States
(12) Patent Application Publication
(10) Pub. No.: US 2003/0180566 A1
(43) Pub. Date: Sep. 25, 2003

(54) Plastic-worked member and production method thereof

(76) Inventors: Shigeru Yanagimoto, Kitakata-shi, Fukushima (JP); Kunio Hirano, Kitakata-shi, Fukushima (JP); Masashi Fukuda, Kitakata-shi, Fukushima (JP); Tomoo Uchida, Kitakata-shi, Fukushima (JP)

Correspondence Address: SUGHRUE MION, PLLC, 2100 PENNSYLVANIA AVENUE, N.W., WASHINGTON, DC, 20037, US

(21) Appl. No.: 10/258,800

(22) PCT Filed: Feb. 28, 2002
(86) PCT No.: PCT/JP02/01857

(30) Foreign Application Priority Data
Feb. 28, 2001 (JP) 2001-055977

(51) Int. Cl. B23P 17/00

(52) U.S. Cl. 428/577; 29/527.5

(57) ABSTRACT

A metal ingot (1) solidified through unidirectional forced-cooling from a cooling member (100) to an end surface of a stopper (13), by the cooling member, of molten metal (1′) teeming via a molten metal inlet (101) of a closable mold (12) into a mold cavity (16) is plastic-worked at percent working equl to or higher than a predetermined level to obtain a plastic-worked member. The end surface of the stopper and the cooling member partially define the mold cavity. The plastic-worked member is improved in mechanical characteristics that have heretofore been inferior on the side of the end surface of the stopper and is increased in entire strength.

### CROSS REFERENCE TO RELATED APPLICATION

This application is an application filed under 35 U.S.C. § 111(a) claiming the benefit pursuant to 35 U.S.C. § 119(e) (1) of the filing date of Provisional Application Serial No. 60/276,501 filed Mar. 19, 2001 pursuant to 35 U.S.C. §111(a).

### TECHNICAL FIELD

The present invention relates to a plastic-worked member obtained through plastic working of an ingot which is produced, by use of a closable mold having a mold cavity which when the mold is closed is partially defined by an end surface of a stopper and a cooling member, through forced-cooling solidification, by use of the cooling member, of molten metal fed via an molten metal inlet; as well as to a production process thereof.

### BACKGROUND ART

Conventionally, as disclosed by, for example, JP-A HEI 9-174198, there has been known a specific type of metal ingot (material to be plastic-worked) produced, by use of a closable mold having a mold cavity which when the mold is closed is partially defined by an end surface of a stopper and a cooling member, through forced-cooling solidification, by use of the cooling member, of molten metal fed via a molten metal inlet so as to attain unidirectional cooling of the melt in a direction running from the cooling member to the stopper.

Metal ingots produced through unidirectional solidification by means of the above technique are free from internal defects, such as cast cavities, shrinkage cavities, pinholes or oxide inclusion, and thus have good quality. In addition, since molten metal is fed into a closable mold, the same amount of molten metal can always teem, thereby eliminating the need for measuring the amount of the molten metal. Moreover, since the meniscus does not assume a large curvature, there is no risk of significant variation in the size and weight of the ingots.

Also, the metallographic structure of the resultant ingot differs between two opposing surfaces, one being on the side of the cooling member end surface, where effects of forced-cooling are significant, and the other being on the side of the stopper end surface, where dendrite arm spacing (which denotes a distance between two adjacent secondary branches of dendrite and will hereinafter be referred to as “DAS”) is longer and grain size is larger.

However, when a metal ingot has a metallographic structure of large DAS and large crystal grain size, as described above, in typical cases, mechanical characteristics of the ingot, such as tensile strength, 0.2% yield strength and elongation, tend to be deteriorated. Therefore, even in the case of a metal ingot produced through the unidirectional solidification, the ingot has poor mechanical characteristics on the side of the stopper end surface as compared with on the cooling member side, resulting in a problematic variation in mechanical strength of the final product obtained using the ingot.

The present invention has been achieved in view of the foregoing, and an object of the invention is to provide a plastic-worked member obtained through plastic working of an ingot which is produced through unidirectional solidification of molten metal, the ingot having improved mechanical characteristics on the side of the stopper end surface so as to attain overall uniform mechanical characteristics; as well as to a production process thereof.

### DISCLOSURE OF THE INVENTION

The plastic-worked member according to the present invention is characterized in that a cast ingot produced in a closable mold through unidirectional forced-cooling of molten metal teeming via a molten metal inlet is plastic-worked at percent working equal to or higher than a predetermined level, wherein the forced-cooling is performed by means of a cooling member, and, when the mold is closed with a stopper, an end surface of the stopper serves as a portion of the inner surface of the mold and the cooling member serves as another portion of the inner surface of the mold.

A production method of the plastic-worked member according to the present invention is characterized by forced-cooling of molten metal teeming via a molten metal inlet into a mold cavity which, when a mold is closed, is partially defined by an end surface of a stopper and by a cooling member to thereby unidirectionally solidify a cast ingot; and plastic-working of the ingot at percent working of at least a predetermined level.

In the plastic-worked member or production method thereof, the percent working equal to or higher than the predetermined level can be attained through single-step or multi-step plastic working of a cast ingot.

In the plastic-worked member or production method thereof, the predetermined level of percent working can be 25% or, when necessary, 50%.

In the plastic-worked member or production method thereof, the plastic working can be partial plastic working performed on the cast ingot or partial plastic working on at least a portion of the cast ingot including a portion on the stopper end surface side.

The plastic-worked member can serve as an intermediate or final product.

In the plastic-worked member or production method thereof, the plastic working is any one of forging (cold or hot), forging-elongation swaging, rolling, extrusion, component rolling and rotary forging (rolling processing).

In the plastic-worked member or production method thereof, the metal is aluminum or aluminum alloy.

In the plastic-worked member or production method thereof, DAS of the metallographic structure as observed on the stopper end surface side is 1.1 to 10.0 times that on the cooling member side.

In the plastic-worked member and production method thereof, the grain size in terms of the metallographic structure as observed on the stopper end surface side is 1.05 to 7 times that on the cooling member side.

In the plastic-worked member and production method thereof, in relation to the size of the grains that form the secondary phase of the plastic-worked member crystal, the grain size as observed on the stopper end surface side is at least 1.2 times that observed on the cooling side.

As described above, plastic working through unidirectional solidification of a metal ingot can improve the mechanical characteristics of the member tending to deteriorate on the stopper end surface side to enable increased strength of the entire member and make strength variation uniform.

### BRIEF DESCRIPTION OF THE DRAWINGS

FIG. 1 is a cross-sectional side view showing the basic structure of a casting apparatus for producing a plastic-worked member of the present invention.

FIG. 2 shows a cast ingot (FIG. 2(a)), a rectangular parallelepiped sample (FIG. 2(b)), and a forged and elongated sample (FIG. 2(c)), respectively, referred to in Example 1.

FIG. 3(a) is a front view of a specimens used in a tensile test, and FIG. 3(a) is a side view thereof.

FIG. 4 shows a cast ingot (FIG. 4(a)), a rectangular parallelepiped sample (FIG. 4(b)), and a forged and elongated sample (FIG. 4(c)), respectively, referred to in Example 2.

FIG. 5 shows a cast ingot (FIG. 5(a)) and a rolled member (FIG. 5(b)), respectively, referred to in Example 3.

FIG. 6 shows a cast ingot (FIG. 6(a)) and a cup-shaped forged member (FIG. 6(b)), respectively, referred to in Example 4.

### BEST MODES FOR CARRYING OUT THE INVENTION

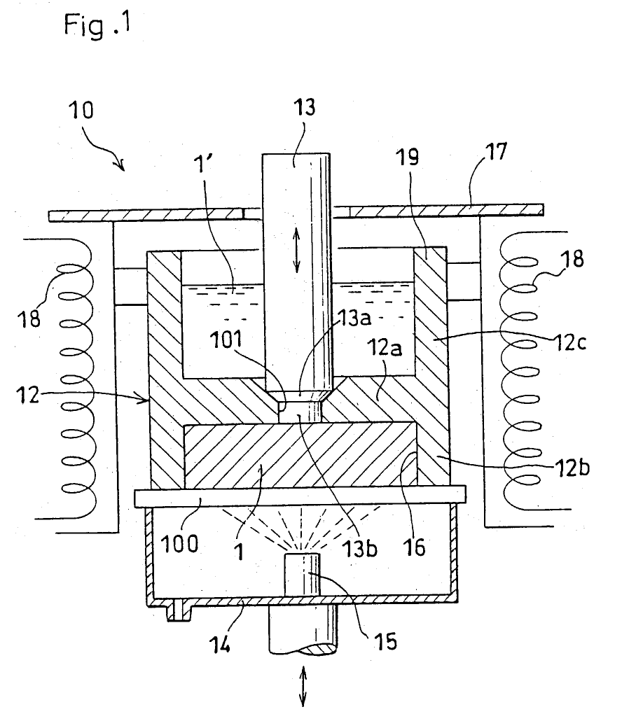

First, a production method of a plastic-worked member according to the present invention will be described with reference to FIG. 1.

FIG. 1 is a cross-sectional side view showing the basic structure of a casting apparatus 10 for producing the plastic-worked member of the present invention. The casting apparatus 10 illustrated in FIG. 1 is used to produce metal ingots which serve as raw materials to be subjected to plastic working, such as cold forging, hot forging, closed forging, rolling, extrusion or component rolling, or to produce a variety of castings such as blanks having the shapes of final products (i.e., material for plastic working or metal ingot). Raw materials for producing castings are typically steel and preferably are non-ferrous metal species, such as aluminum, zinc and magnesium, and their alloys.

As shown in FIG. 1, the casting apparatus 10 includes a cooling plate 100, a mold 12 and a stopper 13.

The cooling plate 100 is formed from metal endowed with excellent refractory properties and high thermal conductivity, such as iron, copper or aluminum, or from a refractory material with high thermal conductivity, such as graphite, silicon carbide or Si₃N₄. The cooling plate 100 has a casing 14 and a spray nozzle 15 on its lower side. The casing 14 has a bottom covering the lower surface of the cooling plate 100. The, spray nozzle 15 for jetting cooling water through jet holes provided at the top of the nozzle is attached to the casing 14, such that a top end of the nozzle 15 has a view of the interior of the casing 14, with the jet holes facing the lower surface of the cooling plate 100. The cooling plate 100, casing 14 and spray nozzle 15 are connected, via the casing 14, to an elevator-driving unit not shown, and, when the elevator-driving unit is driven, can be moved upward and downward as a unit.

The mold 12 is integrally formed of a partition 12a having a diameter smaller than that of the cooling plate 100, a side wall 12b provided along the periphery of the lower surface of the partition 12a and an upper wall 12c provided along the periphery of the upper surface of the partition 12a. The mold 12 is fixedly provided in a region above the cooling plate 100, and when the cooling plate 100 moves downward, the bottom of the mold opens, whereas when the cooling plate 100 moves upward, the bottom of the mold is closed to thereby define a mold cavity 16 closed by the partition 12a, the side wall 12b and the cooling plate 100. Material for forming the mold 12 is determined in consideration of relevant conditions, such as the raw material of casting 1 to be produced, wettability of the mold material with respect to molten metal 1′, temperature during use and corrosion resistance, and can be suitably selected from among heat-insulating refractory materials containing as a predominant component calcium silicate (CaSiO₃), calcium oxide (CaO), silicon dioxide (SiO₂), aluminum oxide (Al₂O₃) or magnesium oxide (MgO); refractory materials of single-component or multi-components selected from among silicon nitride, trisilicon tetranitride, boron nitride-containing trisilicon tetranitride, silicon carbide, graphite, boron nitride, titanium dioxide, zirconium oxide, aluminum nitride and a mixture thereof; and metal species such as iron and copper. Although not shown in FIG. 1, the mold 12 preferably has air passages at appropriate positions of the mold 12 so that the air confined in the cavity 16 can be released upon teeming.

The mold 12 has a molten metal inlet 101 at the central position of the partition 12a. While the lower section of the molten metal inlet 101 has a uniform inner diameter, the upper section thereof has a funnel shape with an upwardly increasing inner diameter. The angle of elevation of the funnel-shaped portion is 15° to 75°, preferably 30° to 60°. The mold 12 employed in the present embodiment is formed of silicon carbide. The position at which the molten metal inlet 101 is placed is not limited to the center of the partition 12a, but may be changed to any position depending on the shape and use of the cast ingot. For example, when the presence of a mark or trace transcribed from the molten metal inlet 101 on the final product plastic-worked is not desired, the position of the inlet can be determined by selecting the portion which will not leave such trace (e.g., a portion which will be removed through, for example, cutting).

The stopper 13 has a cylindrical body, and its lower end portion has a diameter greater than the inner diameter of the lower section of the molten metal inlet 101 but smaller than the inner diameter of the opening of the funnel-shaped portion. It also has a diameter-decreasing portion 13a and a fit end 13b provided downward from the lower end of the cylindrical body. The outer diameter of the portion 13a gradually decreases downward. The fit end 13b also has a cylindrical shape and is formed such that it can be tightly inserted into the lower section of the molten metal inlet 101. The stopper 13 is movable upward and downward with its axis coinciding with the center axis of the molten metal inlet 101, and ascends or descends when urged by a driving force transmitted from a stopper-driving unit not shown. Preferably, the material of the stopper 13 is selected from among heat-insulating refractory materials containing as a predominant component calcium silicate (CaSiO₃), calcium oxide (CaO), silicon dioxide (SiO₂), aluminum oxide (Al₂O₃) or magnesium oxide (MgO); or from among non-metallic materials endowed with excellent refractory/heat-insulating properties and mechanical strength, such as silicon carbide, trisilicon tetranitride and mixtures thereof. It is also possible to employ metallic materials which are non-reactive, or only slightly reactive, with the melt 1′ of iron, cast steel, etc.

In FIG. 1, reference numeral 17 denotes a lid for covering the upper region of the mold 12, and reference numeral 18 denotes an electric furnace connected with the upper wall 12c of the mold 12.

In the production of a cast body 1 by use of the casting apparatus 10 having the above structure, firstly, the elevator-driving unit (not shown) is operated to move the, cooling plate 100 upward to thereby form a mold cavity 16 defined by the mold partition 12a, mold side wall 12b and cooling plate 100. Then, the stopper-driving unit (not shown) is operated to move the stopper 13 downward until the fit end 13b of the stopper 13 is inserted into and fitted in the lower section of the molten metal inlet 101 and the diameter-decreasing portion 13a of the stopper 13 abuts the corresponding funnel-defining wall of the molten metal inlet 101.

When the mold has the above configuration, the molten metal inlet 101 is closed with the stopper 13, and thus the mold cavity 16 is isolated from a reservoir 19 defined by the partition 12a and upper wall 12c of the mold 12. In this connection, preferably, in order to facilitate removal of the cast body 1 from the mold 12, the inner walls of the mold 12 are coated with a mold-releasing agent, and in order to prevent chemical reaction with molten metal 1′, the stopper 13 is also coated with a mold-releasing agent.

Subsequently, the electric furnace 18 is operated to thereby supply a predetermined amount of molten metal 1′ into the aforementioned reservoir 19. Operation of the electric furnace 18 is performed not only for the purpose of maintaining a predetermined temperature of the molten metal 1′ contained in the reservoir 19, but also for the purpose of preventing heat absorption through the side wall 12b so as to attain an improved effect of unidirectional solidification which will be described hereinbelow.

Thereafter, the stopper-driving unit is operated to translate the stopper 13 upward and remove the fit end 13b of the stopper 13 from the lower section of the molten metal inlet 101.

When the mold has the above configuration, the molten metal inlet 101 is open to establish communication between the reservoir 19 and the mold cavity 16, thereby allowing continuous teeming of molten metal 1′ contained in the reservoir 19 into the mold cavity 16 through the molten metal inlet 101 so as to completely fill the cavity. When the stopper 13 is translated upward, the cooling plate 100 is preferably heated to at least 100° C. in advance. Any temperature lower than 100° C. is not preferable, because generation of a blow defect that is a type of casting defect cannot be prevented. The upper limit of the heating temperature is appropriately about the same as that of the molten metal 1′. In order to prevent generation of blow defects, the cooling plate 100 is preferably coated with a mold-releasing agent in advance. Coarsening the surface of the cooling plate 100 through shot blasting is also effective for preventing blow defects.

When the cavity 16 has been completely filled with molten metal 1′, the stopper 13 is again translated downward to close the molten metal inlet 101. Just before completion of teeming, or when the temperature of the cooling plate 100 has arrived at a predetermined temperature after completion of teeming, cooling water is jetted onto the cooling plate 100 through the spray nozzle 15. A thermocouple has been inserted in the cooling plate 100 at the position at which molten metal arrives last so as to monitor a change in temperature of the cooling plate 100. When cooling water is jetted onto the cooling plate 100, molten metal 1′ that fills the mold cavity 16 starts to solidify unidirectionally upward from the bottom. That is, solidification proceeds such that solidification interface (i.e., interface between molten metal and a solidified portion) gradually moves upward from the cooling plate 100 with unidirectionality of the movement being maintained, preferably without forming a closed region. When molten metal 1′ within the mold cavity 16 has been solidified, the cooling plate 100 is translated downward with respect to the mold 12 to release the cast body 1 from the mold 12 onto the cooling plate 100.

The present embodiment provides cast bodies 1 of a variety of shapes in accordance with the configuration of the mold cavity, wherein upper and lower faces are parallel to each other, the upper face being on the side of the stopper 13, and the lower face being on the side of the cooling plate 100. When the configuration of the cavity is changed, cast bodies 1 of arbitrary shapes can be obtained. For example, a combination of the upper and lower faces that are not parallel to each other or a combination of a flat surface and a curved surface may be employed. Also, three-dimensionally profile cast bodies having curved surfaces may be produced. In this case, although solidification interface does not necessarily assume a horizontal flat plane, unidirectionality of solidification is maintained, preventing formation of a closed region.

In the above-described production of a cast body (cast ingot) 1, solidification interface always proceeds unidirectionally without forming a closed region to thereby realize unidirectional solidification. Therefore, the interior of the cast body has excellent quality, being free from defects, such as casting cavities, shrinkage cavities, pinholes and oxide inclusion. Moreover, since the upper space of the mold cavity 16 is closed by the partition 12a and the surface of the lowermost end of the stopper 13, the volume of teeming molten metal never changes, eliminating the need for measuring the volume of molten metal to be teeming. In addition, a large curvature is not formed at the meniscus, and thus there is no risk of significant variation in the size and weight of the cast ingots 1.

The cast ingot 1 was produced from aluminum or aluminum alloy, and DAS and grain size of the ingot was observed under a polarizing microscope (magnification: ×40 to ×100). DAS was measured in accordance with the “Procedure of dendrite arm spacing measurement” described in “Light Metal, vol. 38, No. 1, p. 45 (1988)”, published by the Light Metal Society, and grain size was measured in accordance with the “Metallography” described in “Light Metal, vol. 33, No. 2, p. 111 (1983)” published by the same Society.

Regarding DAS, under the aforementioned unidirectional crystal growth, a notable tendency was observed in which DAS increases as the measurement points approach the stopper 13, (the top surface T of the ingot) from the cooling plate (the bottom surface B of the ingot). When DAS in the vicinity of the bottom surface B is represented by d1 and that in the vicinity of the top surface T is represented by d2, due to the effect of forced-cooling, the relation d1<d2 is obtained. However, when d2<(1.1×d1), the tendency of increase of d2 is insignificant, exhibiting virtually no effect of oriented crystal growth and permitting generation of an increased number of casting defects. On the other hand, when d2>(10×d1), d2 increases excessively, which is impractical from the viewpoint of industrial production of cast ingots. Therefore, preferably, d2 falls within a range of (1.1×d1) to (10×d1), more preferably, (1.1×d1) to (5.0×d1). Also, in order to obtain an enhanced effect of oriented crystal growth, DAS as measured in the vicinity of the bottom surface B is preferably 40 μm or less. When forced-cooling is performed to meet the above conditions, there can be produced a healthy cast ingot having, within an area of 100 mm², no more than one casting defect, such as microporosity or microshrinkage, of 200 μm or more and no more than 10 microcavities of 50 to 200 μm.

The metallographic study of the resultant cast ingots revealed that, similar to the case of DAS, under the aforementioned oriented crystal growth, there is a prominent tendency that the size of grains of crystals forming an equiaxed grain structure increases from the bottom surface B toward the top surface T. When the grain size in the vicinity of the bottom surface B and that in the vicinity of the top surface T are represented by d1′ and d2′, respectively, the relation d1′<d2′ is obtained due to forced-cooling. However, when d2′<(1.05×d1′), the tendency of increase of d2 is insignificant, exhibiting virtually no effect of oriented crystal growth and permitting generation of an increased number of casting defects. On the other hand, when d2′>(7×d1′), d2′ increases excessively, which is impractical from the viewpoint of industrial production of cast ingots. Therefore, preferably, d2′ falls within a range of (1.05×d1′) to (7×d1′), more preferably, (1.05×d1′) to (5×d1′). Also, in order to obtain an enhanced effect of oriented crystal growth, preferably, grain size d1′ on the side of the bottom surface B is 100 μm or less on average.

In the above-described embodiment, cast ingots having a variety of shapes are produced by use of a casting apparatus having the aforementioned structure designed to attain unidirectional solidification of molten metal (i.e., a unidirectional solidification casting apparatus), and the thus-produced ingots are subjected to plastic working, which improves mechanical characteristics of each, ingot, particularly those of a portion in the vicinity of the stopper, thereby eliminating variation in mechanical characteristics of the ingot and attaining uniform mechanical characteristics throughout the ingot.

The term “plastic working” as used herein refers to all possible processes that impart to a material intended shapes and properties through plastic deformation of the material. Examples of plastic working include, but are not limited to, forging (cold or hot), forging-elongation swaging, rolling, extrusion, component rolling and rotary forging. Percent working K of plastic working is (height reduced by deformation)÷(initial height)×100 (%) for the case of swaging or similar working, and (cross-sectional area reduced by deformation)÷(initial cross-sectional area)×100 (%) for the case of extrusion or similar working.

The present invention will next be described with reference to specific examples.

### EXAMPLE 1

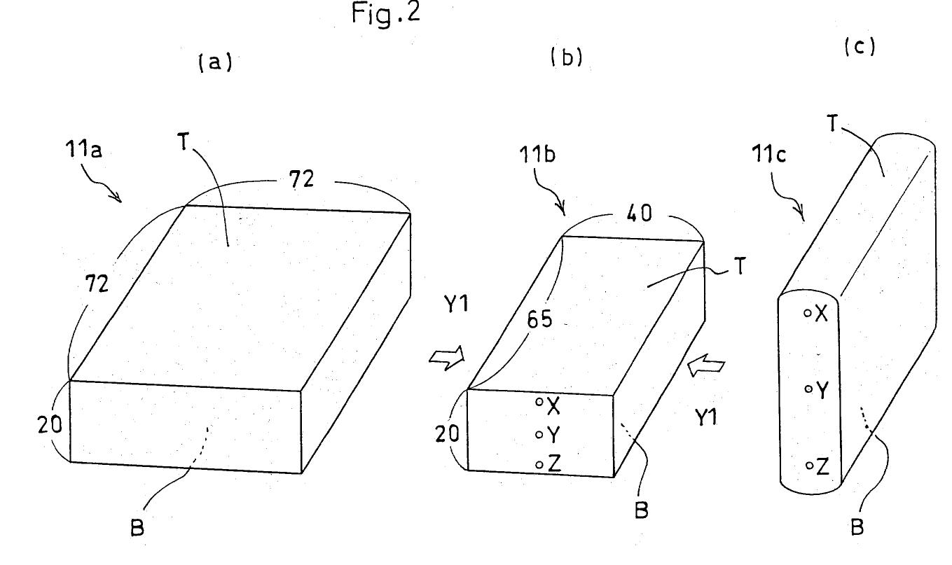

JIS2218 alloy melt was prepared in a separate melting apparatus (not illustrated), and the melt was fed into a unidirectional solidification casting apparatus to cast ingots 11a (FIG. 2(a)) having a length of 72 mm, a width of 72 mm and a thickness of 20 mm. Casting conditions are shown in the column “Example 1” of Table 1 below. Before casting, Al—5 mass % Ti—1 mass % B was incorporated into the molten alloy in such an amount that the resultant alloy had a Ti content of 0.01 mass %, in an attempt to reduce the size of crystal grains. Table 2 below shows the chemical composition of the JIS2218 alloy melt that was subjected to forging.

TABLE 1
Casting Conditions

| Items | Unit | Example 1 | Example 2 | Example 3 | Example 4 |
|---|---|---|---|---|---|
| 1. Alloy Species | | JIS2218 | JIS6061 | JIS6061 | Al—Si-based |
| | | | | | alloy |
| 2. Temperature of Molten Metal in | ° C. | 720 | 750 | 750 | 700 |
| Reservoir | | | | | |
| 3. Difference between levels of | mm | 150 | 100 | 100 | 200 |
| molten metal in reservoir and mold | | | | | |
| cavity just before stopper is | | | | | |
| closed | | | | | |
| 4. Temperature of cooling member | ° C. | 150 | 150 | 150 | 150 |
| before teeming | | | | | |
| 5. Flow rate of cooling water | L/min | 7 | 8 | 7 | 8 |
| 6. Diameter of molten metal inlet | mm | 12 | 10 | 10 | 10 |
| 7. Atmospheric temperature in | ° C. | 750 | 780 | 780 | 720 |
| electric furnace | | | | | |
| 8. Temperature of mold upper wall | ° C. | 680 | 700 | 700 | 680 |
| and upper portion of mold side all | | | | | |

9. Casting procedures

| | | | | |
|---|---|---|---|---|
| 1) Teeming | Stopper | Stopper | Stopper | Stopper |
| | closed in 10 | closed in 10 | closed in 9 | closed in 12 |
| | min | min | min | min |
| 2) Cooling member | Water cooling | Water cooling | Water cooling | Water cooling |
| | initiated at | initiated at | initiated at | initiated at |
| | 500° C. | 500° C. | 500° C. | 500° C. |
| 3) Cooling member | Water cooling | Water cooling | Water Cooling | Water Cooling |
| | terminated at | terminated at | terminated at | terminated at |
| | 30° C. | 30° C. | 30° C. | 30° C. |
| 4) Cooling member | Cooling | Cooling | Cooling | Cooling |
| | member | member | member | member |
| | descending at | descending at | descending at | descending at |
| | 200° C. | 200° C. | 200° C. | 200° C. |
| 5) Removal of metal ingot | Spontaneous | Spontaneous | Spontaneous | Spontaneous |
| | falling | falling | falling | falling |

TABLE 2
Chemical Composition of JIS2218 Alloy (mass %)

| Si | Cu | Mg | Ni | Fe | Ti |
|---|---|---|---|---|---|
| 0.38 | 4.1 | 1.53 | 1.80 | 0.23 | 0.010 |

Each of the cast ingots 11a was subjected to homogenization at 505° C. for eight hours. Thereafter, the cast ingot 11a was cut to obtain a rectangular parallelepiped sample 11b (FIG. 2(b)) having a width of 40 mm, a length of 65 mm and a thickness of 20 mm. The thickness direction of the rectangular parallelepiped sample 11b is identical with the solidification direction of the cast ingot 11a. The upper surface and lower surface, in a thickness direction, of the rectangular parallelepiped sample 11b correspond to the top surface T and bottom surface B of the cast ingot 11a, respectively.

The rectangular parallelepiped sample 11b was heated at 420° C. in a heating furnace, and then subjected to forging-elongation by use of a 400-ton mechanical press under the conditions as shown in Table 3 below to thereby form a forged and elongated sample 11c (FIG. 2(c)). Forging-elongation was performed in a direction represented by arrows Y1 shown in FIG. 2(b) so as to reduce the width (40 mm) of the rectangular parallelepiped sample 11b. Forging-elongation on three levels of severity; i.e., percent working (percent swaging) K of 25%, 50% or 75%, was performed.

TABLE 3
Forging-Elongation Conditions

| | | |
|---|---|---|
| 1 | Type of press | 400-Ton mechanical press (clamp press) |
| 2 | Type of mold | Upper and lower surfaces flat and parallel |
| 3 | Temperature of mold | 200° C.˜220° C. |
| 4 | Lubricant | Water-soluble graphite lubricant applied onto |
| | | mold by spraying |
| 5 | Working temperature | 400° C.˜430° C. |
| 6 | Percent swaging | Preformed by regulating position of drop-end |
| | | of punch (slide) |

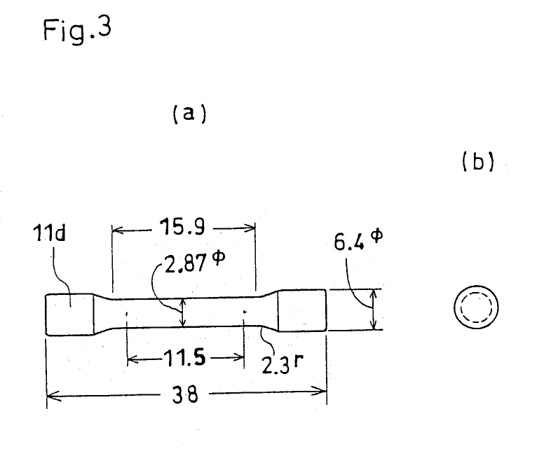

After forging-elongation, the forged and elongated sample 11c was subjected to intentional aging treatment (T6 treatment). Briefly, the sample 11c was subjected to solid solution treatment that is the treatment including heating at 505° C. for four hours and water quenching, and then subjected to tempering at 190° C. for eight hours. In order to evaluate mechanical characteristics of the forged and elongated sample 11c which had undergone T6 treatment, tensile test pieces 11d having a shape as shown in FIG. 3 were prepared, through cutting, from the sample 11c. The shape of each tensile test piece 11d satisfies the dimensional standard (nominal diameter: 0.113 in.) specified by “E8-99, FIG. 8″ of the ASTM standards. The tensile test pieces 11d were obtained from positions X, Y, and Z of the forged and elongated sample 11c as shown in FIG. 2(c). Positions X, Y, and Z correspond to the vicinity of the top surface T of the cast ingot 11a, the center portion of the cast ingot 11a and the vicinity of the bottom surface B of the cast ingot 11a, respectively. Cast ingot sample No. 1 (11a) (rectangular parallelepiped sample 11b) was subjected to forging-elongation at percent working of 25%, and tensile test pieces 11d (FIG. 3) were obtained from positions X, Y and Z of the forged and elongated sample 11c. Cast ingot sample No. 2 (11a) (rectangular parallelepiped sample 11bb) was subjected to forging-elongation at percent working of 50%, and tensile test pieces 11d (FIG. 3) were obtained from positions X, Y and Z of the forged and elongated sample 11c. Cast ingot sample No. 3 (11a) (rectangular parallelepiped sample 11b) was subjected to forging-elongation at percent working of 75%, and tensile test pieces 11d (FIG. 3) were obtained from positions X, Y and Z of the forged and elongated sample 11c. The thus-obtained test pieces were subjected to a tensile test.

The tensile test was performed at a test speed of 1 mm/min by use of an autograph produced by Shimadzu Corporation. Three evaluation items are tensile strength, 0.2% yield strength and elongation.

### COMPARATIVE EXAMPLE 1

For comparison with Example 11 tensile test pieces were formed as follows. Specifically, ingots identical in shape with those of Example 1 were cast from the same alloy melt as in Example 1 through the same casting process as in Example 1. Each of the cast ingots was subjected to homogenization under the same heat treatment conditions as in Example 1, and a rectangular parallelepiped sample having the same shape as in Example 1 was cut from the cast ingot.

Subsequently, the rectangular parallelepiped sample that had not undergone forging-elongation and the rectangular parallelepiped sample that had undergone forging-elongation at percent working of 10% were subjected to T6 treatment under the same conditions as in Example 1. Thereafter, tensile test pieces were prepared, through cutting, from the samples that had undergone T6 treatment.

Forging-elongation at percent working of 10% was performed through the same process as in Example 1. The tensile test pieces were obtained from positions corresponding to the positions X, Y and Z shown in FIG. 2(c). Similarly to the case of Example 1, the positions X and Z correspond to the top surface T and the bottom surface B of the ingot, respectively. The shape of each tensile test piece, tensile test method and evaluation items are the same as in Example 1.

Table 4 below shows data of tensile strength, 0.2% yield strength and elongation obtained in the tensile test. The test results show that when percent swaging is 25% or more, tensile strength, 0.2% yield strength and elongation are remarkably improved. Particularly, the properties at position X corresponding to the top surface are remarkably improved. When percent swaging is 50% or more, the properties at the top surface T and the center portion are similar to those at the bottom surface B, which generally exhibit more favorable properties as compared with the top surface or center portions.

TABLE 4
Tensile Test Results (Example 1 and Comparative Example 1)

| | | | | Example 1 | | | Comparative Example 1 | |
|---|---|---|---|---|---|---|---|---|
| Percent Swaging (K %) | | | | 25 | 50 | 75 | 0 | 10 |
| Tensile strength | Portion | X | Top surface | 372 | 380 | 381 | 314 | 330 |
| (Mpa) | | Y | Center portion | 381 | 384 | 385 | 360 | 365 |
| | | Z | Bottom | 382 | 381 | 382 | 382 | 380 |
| | | | surface | | | | | |
| 0.2% Yield | Portion | X | Top surface | 246 | 246 | 247 | 243 | 245 |
| strength (Mpa) | | Y | Center portion | 245 | 249 | 248 | 247 | 249 |
| | | Z | Bottom | 246 | 247 | 248 | 248 | 247 |
| | | | surface | | | | | |
| Elongation (%) | Portion | X | Top surface | 12.8 | 16.7 | 18.0 | 5.8 | 7.2 |
| | | Y | Center portion | 13.9 | 16.9 | 17.1 | 7.3 | 8.6 |
| | | Z | Bottom | 15.6 | 17.6 | 18.5 | 10.0 | 11.2 |
| | | | surface | | | | | |

On the other hand, in the rectangular parallelepiped sample that had not undergone forging-elongation and the rectangular parallelepiped sample that had undergone forging-elongation at percent working of 10% referred to in Comparative Example 1, there was no discernible improvement on the top surface.

### EXAMPLE 2

In Example 1, forging-elongation was performed in a single step. In Example 2, however, it was performed in a plurality of steps.

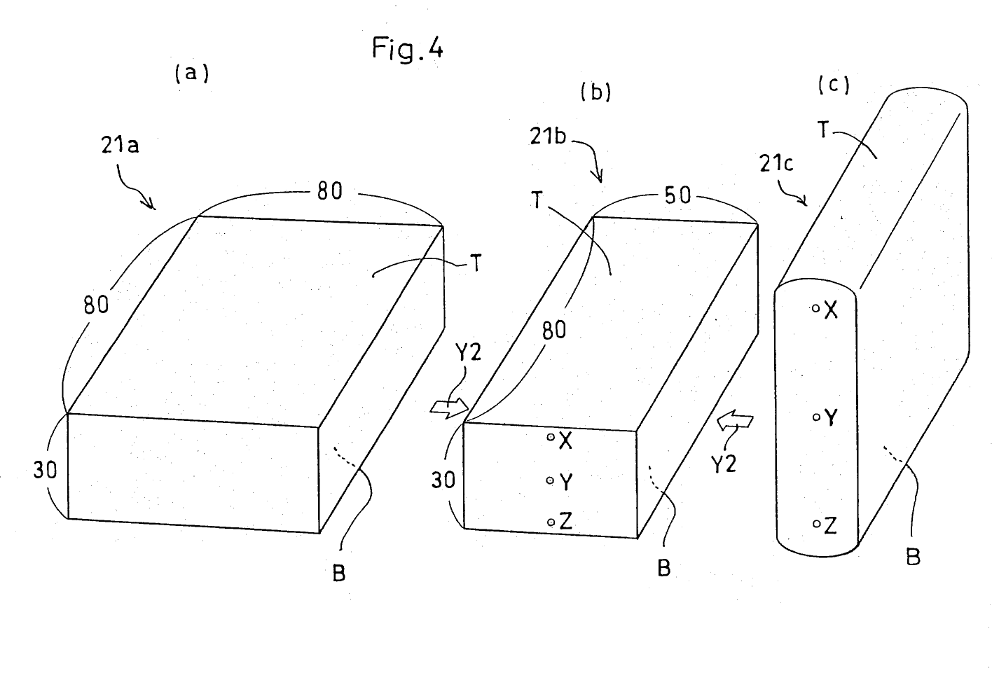

JIS6061 alloy melt was prepared in a separate melting apparatus (not illustrated), and the melt was fed into a unidirectional solidification casting apparatus to cast ingots 21a (FIG. 4(a)) having a length of 80 mm, a width of 80 mm and a thickness of 30 mm. Casting conditions are shown in the column “Example 2” of Table 1 above. Before casting, Al—5 mass % Ti—1 mass % B was incorporated into the molten alloy in such an amount that the resultant alloy had a Ti content of 0.01 mass %, in an attempt to reduce the size of crystal grains. Table 5 below shows the chemical composition of the JIS6061 alloy melt that was subjected to casting.

TABLE 5
Chemical Composition of JIS6061 Alloy (mass %)

| Si | Cu | Mg | Cr | Fe | Ti |
|---|---|---|---|---|---|
| 0.55 | 0.24 | 1.12 | 0.25 | 0.22 | 0.011 |

Each of the cast ingots 21a was subjected to homogenization at 540° C. for six hours. Thereafter, the cast ingot 21a was cut to obtain a rectangular parallelepiped sample 21b (FIG. 4(b)) having a width of 50 mm, a length of 80 mm and a thickness of 30 mm. The thickness direction of the rectangular parallelepiped sample 21b is identical with the solidification direction of the cast ingot 21a. The upper surface and lower surface, in a thickness direction, of the rectangular parallelepiped sample 21b correspond to the top surface T and bottom surface B of the cast ingot 21a, respectively.

The rectangular parallelepiped sample 21b was subjected to hot or cold forging-elongation (swaging) to thereby form a forged and elongated sample 21c (FIG. 4(c)). Hot or cold forging-elongation was performed in two steps in a direction represented by arrows Y2 shown in FIG. 4(b) so as to reduce the width (50 mm) of the rectangular parallelepiped sample 21b. Cold forging-elongation was performed so as to attain percent working (percent swaging) K of 25% as determined after the sample had undergone the two steps, and hot forging-elongation was performed so as to attain percent working (percent swaging) K of 50% as determined after the sample had undergone the two steps.

The 25% forging-elongation was performed as follows. Firstly,, a metallic soap film serving as a lubrication film was formed, on the rectangular parallelepiped sample 21b, and then the resultant sample was subjected to 15% swaging by use of a 400-ton mechanical press. Thereafter, the resultant sample 21b was subjected to annealing at 360° C. for four hours, a metallic soap film was again formed on the annealed sample, and the resultant sample was subjected to 10% swaging by use of a press, to thereby attain a total percent swaging of 25%.

The 50% forging-elongation was performed as follows. Firstly, the rectangular parallelepiped sample 21b was heated to 420° C. in a heating furnace, and subsequently, the resultant sample was subjected to two-step swaging, 25% for each step, under the forging-elongation (swaging) conditions shown in Table 3 above, to thereby attain a total percent swaging of 50%. In the course of the two-step swaging, the sample underwent cooling to room temperature and re-heating to 420° C.

After the forging-elongation, the forged and elongated sample 21c was subjected to intentional aging treatment (T6 treatment). Briefly, the sample 21c was subjected to solid solution treatment, which is the treatment including heating at 540° C. for four hours, and then subjected to tempering at 170° C. for eight hours. In order to evaluate mechanical characteristics of the forged and elongated sample 21c that had undergone T6 treatment, tensile test pieces were obtained from the sample 21c through the same method as in Example 1, and then subjected to a tensile test. The test apparatus, test method and evaluation items are the same as those of Example 1.

In Example 2, percent working of 25% or 50% was attained through two-step forging-elongation. In Example 2A, a rectangular parallelepiped sample having the same shape as that of the rectangular parallelepiped sample of Example 2 was cut from a cast ingot obtained under the same conditions as in Example 2, and the rectangular parallelepiped sample was subjected to forging-elongation to thereby form a forged and elongated sample. In Example 2A, the rectangular parallelepiped sample was heated at 420° C., and then the sample was subjected to swaging in a single step, so as to attain (1) a percent swaging of 25% or (2) a percent swaging of 50%. Tensile test pieces were obtained from the resultant forged and elongated sample, and then subjected to a tensile test. The test results were compared with those of Example 2. Other conditions are the same as those of Example 2.

Table 6 below shows data of tensile strength, 0.2% yield strength and elongation obtained in the tensile test in Examples 2 and 2A. The test results show that mechanical characteristics of the sample that had undergone forging-elongation in a single step are similar to those of the sample that had undergone forging-elongation in two steps.

TABLE 6
Tensile Test Results (Examples 2 and 2A)

| | | | | Example 2 | | Example 2A | |
|---|---|---|---|---|---|---|---|
| Total percent swaging ( K%) | | | | 25 | 50 | 25 | 50 |
| Processing classification | | | | Cold | Hot | Cold | Hot |
| Forging-elongation process | | | | 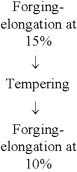 | 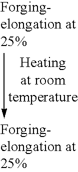 | Single- step forging- elongation at up to 25% | Single- step forging- elongation at up to 50% |
| Tensile strength (Mpa) | Portion | X | Top surface | 347 | 351 | 346 | 351 |
| | | Y | Center portion | 355 | 358 | 354 | 357 |
| | | Z | Bottom surface | 354 | 354 | 355 | 353 |
| 0.2% Yield strength (MPa) | Portion | X | Top surface | 313 | 315 | 313 | 314 |
| | | Y | Center portion | 318 | 318 | 312 | 314 |
| | | Z | Bottom surface | 315 | 316 | 314 | 316 |
| Elongation (%) | Portion | X | Top surface | 15.2 | 18.3 | 15.4 | 18.2 |
| | | Y | Center portion | 15.1 | 18.7 | 15.1 | 18.8 |
| | | Z | Bottom surface | 15.2 | 18.8 15.1 | 18.9 | |

### EXAMPLE 3

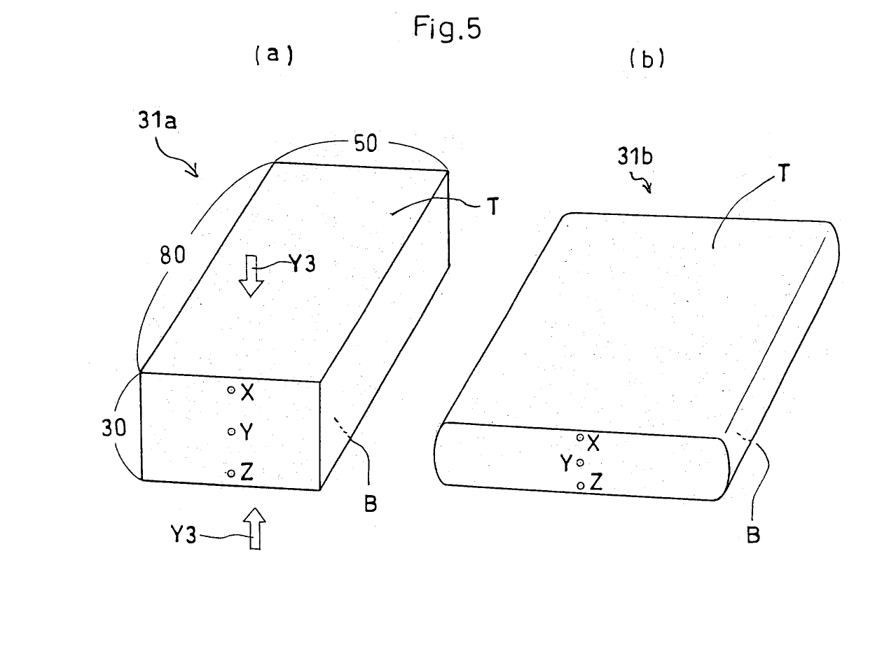

In Example 3, as plastic working, rolling was performed in a plurality of steps. Firstly, JIS6061 alloy melt (the same material as used in Example 2) was prepared in a separate melting apparatus (not illustrated), and the melt was fed into a unidirectional solidification casting apparatus to thereby cast ingots 31a (FIG. 5(a)) having a length of 80 mm, a width of 50 mm and a thickness of 30 mm. Casting conditions are shown in the column “Example 3” of Table 1 above. Table 5 above shows the chemical composition of the molten alloy that was subjected to casting.

Each of the cast ingots 31a was subjected to homogenization at 550° C. for six hours, and then subjected to rolling. The thickness direction and solidification direction of the cast ingot 31a are identical with each other. The upper surface and lower surface, in a thickness direction, of the cast ingot 31a correspond to the top surface T and bottom surface B of the cast ingot 31a, respectively.

Rolling was performed by use of a two-stage rolling apparatus. Before rolling, rolls were pre-heated to 150° C., and the cast ingot 31a was pre-heated to 400° C. in a heating furnace. During rolling, the cast ingot was pressed in a direction represented by arrows Y3 shown in FIG. 5(a) so as to reduce the thickness (30 mm). Rolling was performed in five steps until percent working (rolling reduction) K became 25%, such that the rolling direction was the longitudinal direction of the cast ingot. In each step, rolling reduction was 5% with respect to the thickness of the cast ingot before rolling; i.e., the reduction in thickness was 1.5 mm in each step. Rolling was performed without use of a lubricant.

The resultant rolled sample 31b was subjected to T6 treatment in a manner similar to that of Example 2. Subsequently, tensile test pieces, were obtained from the rolled sample at positions X, Y and Z shown in FIG. 5(b) along a direction parallel to the rolling direction, and were then subjected to a tensile test. The test apparatus, test method, and evaluation items are the same as those of Example 1.

In Example 3, percent working of 25% was. attained after completion of five-step rolling. In contrast, in Example 3A, percent working of 25% was attained through forging-elongation in a single step, and the results of Example 3 were compared with those of Example 3A. Briefly, in Example 3A, a cast ingot obtained under the same conditions as those of Example 3 was heated at 400° C., and subjected to swaging in a single step, so as to attain a percent swaging of 25%. Subsequently, tensile test pieces were prepared from the resultant forged and elongated sample, and then subjected to a tensile test. Other conditions are the same as those of Example 3.

In Comparative Example 3, tensile test pieces were obtained from the cast ingot 31a (FIG. 5(a)) which had not been subjected to plastic working, such as rolling or forging-elongation, at positions X, Y, and Z shown in FIG. 5(a) along the longitudinal direction of the cast ingot 31a. Subsequently, the test pieces were subjected to a tensile test. Other conditions are the same as those of Example 3.

Table 7 below shows data of tensile strength, 0.2% yield strength and elongation obtained in the tensile test in Examples 3 and 3A and Comparative Example 3. The test results show that mechanical characteristics of the sample which had undergone rolling in five steps are substantially similar to those of the sample which had undergone forging-elongation in a single step, and that, in Examples 3 and 3A, mechanical characteristics are clearly improved as compared with the case of Comparative Example 3, in which percent working is 0%.

TABLE 7
Tensile Test Results (Examples 3 and 3A and Comparative Example 3)

| | | |
|---|---|---|
| | | Comparative |
| Example 3 | Example 3A | Example 3 |

| Total percent working | | | | Rolling | Percent | 0 |
|---|---|---|---|---|---|---|
| | | | | reduction 25% | swaging 25% | |
| Working process | | | | Five-step | Single-step | |
| | | | | continuous | forging- | |
| | | | | rolling at 5% in | elongation at up | |
| | | | | each step | to 25% | |
| Tensile strength | Portion | X | Top surface | 347 | 345 | 340 |
| (Mpa) | | Y | Center portion | 352 | 353 | 347 |
| | | Z | Bottom surface | 354 | 353 | 348 |
| 0.2% Yield strength | Portion | X | Top surface | 313 | 312 | 301 |
| (Mpa) | | Y | Center portion | 315 | 314 | 303 |
| | | Z | Bottom surface | 315 | 314 | 304 |
| Elongation (%) | Portion | X | Top surface | 15.0 | 15.1 | 14.1 |
| | | Y | Center portion | 15.1 | 15.0 | 13.9 |
| | | Z | Bottom surface | 15.0 | 15.0 | 13.8 |

### EXAMPLE 4

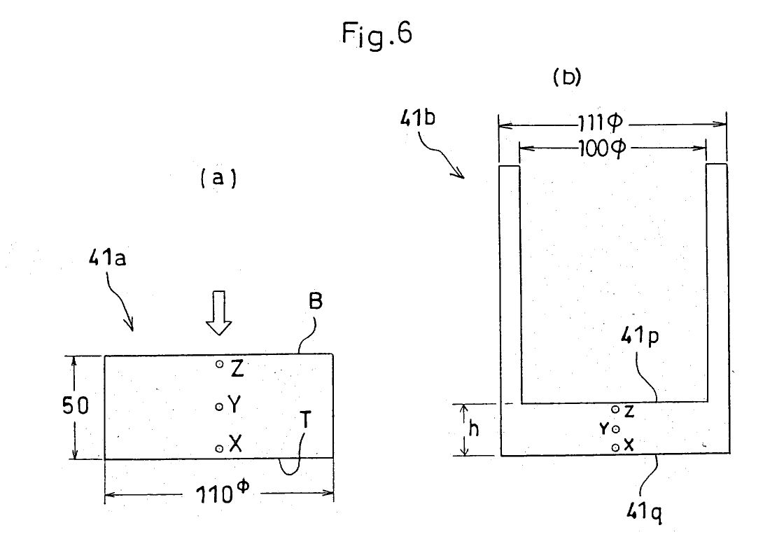

In Example 4, hot forging was performed as plastic working. Firstly, an Al—Si—Cu—Mg-based alloy melt was prepared in a separate melting apparatus (not illustrated), and the melt was fed into a unidirectional solidification casting apparatus, to thereby cast columnar ingots 41a (FIG. 6(a)) having a diameter of 110 mm and a thickness of 50 mm. Casting conditions are shown in the column “Example 4” of Table 1 above. The thickness direction and solidification direction of the cast ingots 41a are identical with each other. Table 8 below shows the chemical composition of the molten alloy that was subjected to casting.

TABLE 8
Al—Si—Cu—Mg-Based Alloy (mass %)

| Si | Cu | Mg | Fe |
|---|---|---|---|
| 13.1 | 3.1 | 0.38 | 0.21 |

Each of the cast ingots 41a was subjected to homogenization at 490° C. for eight hours. Thereafter, the cast ingot 41a was placed in a die such that the bottom surface B and top surface T of the cast ingot were the upper surface and lower surface, respectively, and the cast ingot was pressed in a vertical direction by use of a punch and then forged into a cup-shaped forged sample 41b having an outer diameter of 111 mm and an inner diameter of 100 mm as shown in FIG. 6(b). The cup-shaped sample was subjected to hot forging under the conditions shown in Table 9 below. Percent working K of 25%, 50% or 75% was attained, with the drop-end of the punch regulated so as to attain a different bottom thickness h (FIG. 6(b)) of the cup-shaped forged sample 41b. Forging was performed through backward extrusion, and lubricant was sprayed to the punch and the die used for forging. After forging, the forged sample was subjected to T6 treatment (solid solution treatment: at 490° C. for four hours, tempering: at 170° C. for 10 hours). Tensile test pieces were obtained from the resultant forged sample at positions X, Y and Z shown in FIG. 6(b), and then subjected to a tensile test. The test apparatus, test method and evaluation items are the same, as those of Example 1.

TABLE 9
Cup Forging Conditions

| | | |
|---|---|---|
| 1 | Type of press | 800-Ton mechanical press |
| 2 | Temperature of mold | 200° C.˜220° C. |
| 3 | Type of lubricant | Water-soluble graphite lubricant |
| 4 | Working temperature | Heated to 400° C.˜430° C. |
| 5 | Percent working K(%) | Position of drop-end of punch (sliding |
| | | amount) regulated to attain 25%, 50% and |
| | | 75% |

Samples for observation under a microscope were obtained from the cup-shaped sample 41b forged at percent working K of 50%. The samples were obtained at the following five positions: a position 1 mm inside an inner bottom surface 41p shown in FIG. 6(b), a position 3 mm inside the surface 41p, the center between the surface 41p and an outer bottom surface 41q shown in FIG. 6(b), a position 3 mm inside the surface 41q and a position 1 mm inside the surface 41q. The sample for observation under a microscope was polished and then subjected to measurement of secondary phase crystal grains by use of an image processing apparatus. The term “secondary phase crystal grains” used herein refers to eutectic silicon grains and primary silicon crystal grains. “Cosmozone R500” (product of Nikon Corporation) was used as the image processing apparatus. Eutectic silicon grains and primary silicon crystal grains were observed under a microscope, and eutectic silicon grain sizes and primary silicon crystal grain sizes were measured at 800 and 200 magnifications, respectively.

The size of a grain refers to the diameter of a circle having the same area as that of the grain; i.e., a circle-equivalent diameter (Heywood diameter). The grain size was obtained by averaging the sizes of grains present in the field of view. Regarding eutectic silicon grains and primary silicon crystal grains, the ratio of the average size of grains at each of the aforementioned positions to the average size of grains at the position 1 mm inside the surface 41p was calculated.

### COMPARATIVE EXAMPLE 4

In Example 4, hot forging was performed at percent working of 25% or more, but in Comparative Example 4, it was performed at percent working of 0% or 10%. The results of Comparative Example 4 were compared with those of Example 4. Briefly, in Comparative Example 4, cast ingots were produced under the same conditions as employed in Example 4, and each of the cast ingots was subjected to hot forging under the conditions shown in Table 9 above to thereby form a cup-shaped forged sample. The cast ingot (percent working: 0%) and the cup-shaped forged sample (percent working: 10%) were subjected to T6 treatment. Tensile test pieces were obtained from the thus-treated cast ingot and forged sample. The cast ingot was subjected to hot forging under the same conditions as employed in Example 4, except that percent working was varied.

### COMPARATIVE EXAMPLE 5

In Example 4, the cast ingot was produced through unidirectional solidification casting. In Comparative Example 5, a cast ingot was produced by means of a continuous casting method disclosed in, for example, JP-B SHO 54-42847, and the cast ingot was compared with that of Example 4. Briefly, in Comparative Example 5, a continuous cast bar having a diameter of 115 mm was formed from the same molten alloy as employed in Example 4. The cast bar was produced by means of a gas-pressurized hot top casting method disclosed in JP-B SHO 54-42847. The casting conditions are shown in Table 10 below.

TABLE 10
Casting Conditions in Gas-Pressurized Hot Top Casting Method

| | | |
|---|---|---|
| 1 | Temperature of molten metal | 730° C. |
| 2 | Flow rate of cooling water | 40 L/min |
| 3 | Casting rate | 180 mm/min |
| 4 | Type of lubricant | Castor oil |
| 5 | Flow rate of lubricant | 1 cc/min |
| 6 | Type of gas | Air |
| 7 | Flow rate of gas | 0.5 L/min |
| 8 | Header overhang length | 10 mm |

The thus-produced continuous cast bar (cast ingot) was subjected to homogenization, a surface portion of the cast bar was removed so as to attain a diameter of 110 mm, and the bar was cut into round slices (samples) having a thickness of 50 mm. Thereafter, each of the samples was subjected to hot forging at percent working of 50% to thereby form a cup-shaped sample as shown in FIG. 6(b). After the cup-shaped sample was subjected to T6 treatment, tensile test pieces and specimens for observation under a microscope were obtained from the cup-shaped sample. Homogenization conditions, forging conditions, T6 treatment conditions, the shape of each tensile test piece, a tensile test method and a procedure for preparing specimens for observation under a microscope are the same as those employed in Example 4. Positions at which the specimens for observation under a microscope were obtained and a method for measuring the size of secondary phase crystal grains are the same as in Example 4.

Table 11 below shows data of tensile strength, 0.2% yield strength and elongation obtained in the tensile test in Example 4 and Comparative Examples 4 and 5. The test results show that, in Comparative Example 4 in which percent working is 0% or 10%, mechanical characteristics (tensile strength, 0.2% yield strength and elongation) at the top surface T and at the center portion are lower than those at the bottom surface B, and that, in Example 4 in which percent working is 25% or more, mechanical characteristics at the top surface T and the center portion are greatly improved, and the properties at the top surface T and the center portion are substantially the same as those at the bottom surface B when percent working is 50% or more.

TABLE 11
Tensile Test (Example 4 and Comparative Examples 4 and 5)

| | | | | | | | Comparative | | Comparative |
|---|---|---|---|---|---|---|---|---|---|
| | | | | Example 4 | | | Example 4 | | Example 5 |
| Percent swaging (K %) | | | | 25 | 50 | 75 | 0 | 10 | 50 |
| Tensile strength | Portion | X | Top surface | 385 | 395 | 403 | 365 | 370 | 392 |
| (Mpa) | | Y | Center portion | 393 | 396 | 402 | 377 | 385 | 394 |
| | | Z | Bottom surface | 401 | 402 | 405 | 386 | 392 | 401 |
| 0.2% Yield | Portion | X | Top surface | 324 | 328 | 329 | 314 | 317 | 327 |
| strength (Mpa) | | Y | Center portion | 329 | 328 | 328 | 322 | 327 | 327 |
| | | Z | Bottom surface | 329 | 330 | 329 | 327 | 326 | 328 |
| Elongation (%) | Portion | X | Top surface | 4.8 | 6.9 | 7.8 | 4.1 | 3.9 | 7.2 |
| | | Y | Center portion | 5.3 | 7.4 | 8.2 | 4.0 | 4.2 | 7.6 |
| | | Z | Bottom surface | 6.3 | 7.9 | 8.2 | 4.5 | 4.7 | 7.3 |

When percent working K is 75%, an increase in tensile strength is no longer observed, or the degree of increase in tensile strength is reduced. However, elongation tends to be improved even at percent working of 75%. Particularly, at the top surface, further improvement of elongation is observed.

In contrast, mechanical characteristics of the cup-shaped sample produced from the continuous cast bar at percent working K of 50% in Comparative Example 5 are substantially the same as those of the sample (percent working K: 50%) in Example 4.

Tables 12 and 13 below show the results of measurement of the size of secondary phase crystal grains in Example 4 and Comparative Example 5, respectively. As shown in Table 12 below, regarding the size of secondary phase crystal grains of the cup-shaped forged sample 41b obtained in Example 4, the size of eutectic silicon grains tends to increase in a downward direction from the inner bottom surface 41p toward the outer bottom surface 41q, and the ratio of the average size of the eutectic silicon grains at “the position 1 mm inside the outer bottom surface 41q” to that of the grains at “the position 1 mm inside the inner bottom surface 41p” is 2.67.

TABLE 12
Regarding Size of secondary Phase Crystal Grains of Cup Obtained in Example 4

| | | | | Primary silicon | | |
|---|---|---|---|---|---|---|
| | | Eutectic silicon | | | | Ratio of |
| | | | Ratio of | | | average size |
| | | | average size | | | of crystal |
| | | Average | of crystal | Number | Average | grains to that |
| | | size of | grains to that | of grains | size of | at inner |
| | | crystal | at inner | in field of | crystal | bottom |
| Type of secondary phase crystal grains | | grains | bottom | view of | grains | surface of |
| Regarding secondary phase crystal grains | | (μm) | surface of cup | 0.307 mm² | (μm) | cup |
| Portion | 1 mm inside inner bottom surface | 1.8 | 1.00 | 18 | 9.7 | 1.00 |
| observed | 3 mm inside inner bottom surface | 2.2 | 1.22 | 22 | 11.7 | 1.22 |
| | Center portion | 3.9 | 2.17 | 28 | 13.8 | 1.42 |
| | 3 mm inside outer bottom surface | 4.6 | 2.56 | 40 | 14.7 | 1.52 |
| | 1 mm inside outer bottom surface | 4.8 | 2.67 | 42 | 15.2 | 1.57 |

TABLE 13
Regarding Size of secondary Phase Crystal Grains of Cup Obtained in Example 5

| | | | | Primary silicon | | |
|---|---|---|---|---|---|---|
| | | Eutectic silicon | | | | Ratio of |
| | | | Ratio of | | | average size |
| | | | average size | | | of crystal |
| | | Average | of crystal | Number | Average | grains to that |
| | | size of | grains to that | of grains | size of | at inner |
| | | crystal | at inner | in field of | crystal | bottom |
| Type of secondary phase crystal grains | | grains | bottom | view of | grains | surface of |
| Regarding secondary phase crystal grains | | (μm) | surface of cup | 0.307 mm² | (μm) | cup |
| Portion | 1 mm inside inner bottom surface | 2.5 | 1.00 | 44 | 13.6 | 1.00 |
| observed | 3 mm inside inner bottom surface | 2.3 | 0.92 | 40 | 13.9 | 1.02 |
| | Center portion | 2.5 | 1.00 | 48 | 14.0 | 1.03 |
| | 3 mm inside outer bottom surface | 2.4 | 0.96 | 37 | 14.1 | 1.04 |
| | 1 mm inside outer bottom surface | 2.5 | 1.00 | 44 | 13.9 | 1.02 |

The number of primary silicon crystal grains present in the field of view of 0.307 mm² increases in a downward direction from the inner bottom surface 41p toward the outer bottom surface 41q, and the average size of the crystal grains increases in the same downward direction. The ratio of the average size of the crystal grains at “the position 1 mm inside the outer bottom surface 41q” to that of the grains at “the position 1 mm inside the inner bottom surface 41p” is 1.57.

As shown in Table 13 above, regarding the secondary phase grains of the cup-shaped sample obtained in Comparative Example 5, at any of the aforementioned positions, the size of eutectic silicon grains is substantially the same from position to position, and the size of primary crystal grains is also substantially the same from, position to position. The number of the primary silicon crystal grains present in the field of view of 0.307 mm² is substantially the same throughout the aforementioned positions.

Each of the samples of Example 4 and Comparative Example 5 having the aforementioned secondary phase crystal grains was subjected to evaluation of wear resistance at two positions, namely, “the position 1 mm inside the inner bottom surface” and “the position 1 mm inside the outer bottom surface.”

A wear resistance test apparatus and test conditions are described below.

(1) Test apparatus: wear test apparatus TRI-S500 (product of Takachiho Seiki Co., Ltd.)

(2) Test method: pin-on-disk method

(3) Disk material: FC230

(4) Lubricant oil: Clean SF-GF2 (product of Castle Oil Co., Ltd.)(Temperature: 80° C.).

(5) Press loading: 5 kgf

(6) Sliding rate: 0.25 m/second

(7) Sliding time: 60 minutes

(8) Shape of pin: 7.98 mm in diameter and 20 mm in height

Evaluation items were the “amount of loss by wear” and “hardness.” Wear resistance test pieces were obtained from the cup-shaped sample, from which the tensile test pieces were obtained, at the aforementioned two positions. Each of the test pieces was formed into a columnar pin for a wear resistance test, such that the axial direction of the pin was identical with the thickness direction of the bottom portion of the cup-shaped sample. The pin was subjected to T6 treatment serving as heat treatment.

Hardness test pieces were obtained from positions adjacent to the positions from which the wear resistance test pieces were obtained, and subjected to hardness measurement by use of a Rockwell hardness meter. Rockwell B scale (HRB) was used as a hardness scale.

Table 14 below shows the results of the wear resistance evaluation test in Example 4 and Comparative Example 5. As shown in Table 14 below, in Comparative Example 5, there is slight difference in the amount of loss by wear of the sample between the positions at the inner bottom surface and the outer bottom surface. The test results show that the amount of loss by wear of the sample of Example 4 at “the position 1 mm inside the inner bottom surface” is equal to that of the sample of Comparative Example 5 at the corresponding position, but the amount of loss by wear of the sample of Example 4 at “the position 1 mm inside the outer bottom surface” is remarkably low, and is about 50% that at “the position 1 mm inside the inner bottom surface.” That is to say, the outer bottom surface of the sample of Example 4 exhibits improved wear resistance. Meanwhile, the hardness (HRB) of the test pieces obtained from the sample of Example 4 is substantially equal to that of the test pieces obtained from the sample of Comparative Example 5.

TABLE 14
Hardness and Amount of Loss by Wear of Pin

| | | Example 4 | | Comparative Example 5 | |
|---|---|---|---|---|---|
| | | Hardness | Amount of loss by | Hardness | Amount of loss |
| | | (HRB) | wear (μm) | (HRB) | by wear (μm) |
| Portion | 1 mm inside inner bottom surface | 80 | 78 | 79 | 78 |
| Observed | 1 mm inside outer bottom surface | 79 | 41 | 79 | 76 |

Why the outer bottom surface of the cup-shaped, forged sample 41b in Example 4 exhibits excellent wear resistance, is thought to be as follows. Even after the cast ingot produced through unidirectional solidification casting is forged into a cup-shaped sample, the size of eutectic silicon grains and primary silicon crystal grains is large at the outer bottom surface of the cup-shaped forged sample that corresponds to the top surface T of the cast ingot. Therefore, wear resistance at the outer bottom surface is improved.

The difference in the aforementioned properties between the cup-shaped forged sample 41b of Example 4 and the cup-shaped sample of Comparative Example 5 is considered to be attributed to the difference in crystal structure between the raw materials (cast ingots) that form the respective samples. That is, although the inventive concept based on the difference in crystal structure between the cooling member side and the stopper side is applied to the raw material (cast ingot) of the cup-shaped forged sample 41b of Example 4, such a concept is not applicable to the blank for forming the cup-shaped sample of Comparative Example 5, which is obtained by cutting a continuous cast bar into round slices and inherently has a uniform crystal structure at either end portion.

In each of the Examples, the plastic-worked sample produced from the cast ingot obtained through unidirectional solidification casting was subjected to measurement of the size of secondary phase crystal grains (eutectic silicon grain size and primary silicon crystal grain size). As a result, the ratio of the grain size on the stopper side of the plastic-worked sample to that on the cooling member side of the sample is 1.2 or more.

When the cast ingot produced through unidirectional solidification casting, which has the aforementioned characteristics, is subjected to plastic working to thereby form a sample having a predetermined shape, high strength can be imparted to a certain portion of the sample, and high wear resistance can be imparted to another portion of the sample. For example, when the cast ingot is formed into the aforementioned cup-shaped sample, high strength can be imparted to the inner bottom surface, which does not require wear resistance, and high strength and wear resistance can be imparted to the outer bottom surface, which requires wear resistance.

Recent lightweight, highly rigid internal combustion engine pistons produced from an aluminum alloy must have high thermal conductivity and wear resistance. Specifically, a piston head portion and a ring groove portion must have wear resistance, low thermal expansion property and thermal shock resistance. Meanwhile, a piston skirt portion and a pin boss portion, which are greatly deformed through plastic working, must have high deformability and mechanical workability as well as high fatigue strength during use. When a cast ingot of the present invention is placed such that its surface facing the stopper is directed downward, and the center of its upper surface facing the cooling member is pressed, the ingot portion on the stopper side extends to the ring groove portion. This enables formation of a piston head portion and a ring groove portion on the side of the stopper exhibiting excellent wear resistance and formation of a piston skirt portion and a pin boss portion on the side of the cooling member. The thus-formed piston head portion and ring groove portion exhibit high strength and wear resistance, and the piston skirt portion and pin boss portion exhibit excellent strength. Thus, when the plastic-worked material of the present invention is employed, the resultant product satisfies property requirements that differ from portion to portion.

As described above, in the embodiments of the present invention, since the cast ingot 1 (11a, 21a, 31a, 41a) obtained through unidirectional solidification casting is subjected to plastic working to thereby form a plastic-worked member, poor mechanical characteristics of the top surface of the cast ingot can be considerably improved, the strength of the entire member produced from the cast ingot obtained through unidirectional solidification casting can be increased, and variation in strength can be reduced.

Conventionally, the cast ingot 1 obtained through unidirectional solidification casting, having excellent internal quality and low variation in size and weight, has been used as a valuable product. As described above, since the strength of the plastic-worked member produced from the ingot is increased and variation in the strength is reduced, the member can be used as a structural member requiring strength.

In the aforementioned Examples, forging-elongation, rolling or hot forging is performed as plastic working. However, in the present invention, there can be employed any other plastic working for imparting intended shape and properties to a material utilizing material plastic deformation, such as cold forging, component rolling, rotary forging (rolling processing) or extrusion.

The aforementioned plastic-worked member produced by subjecting the cast ingot to plastic working may be a final product, or an intermediate product which requires further processing so as to yield a final product.

In the embodiments described hereinabove, the pressing direction of the cast ingot in the course of plastic working is the width direction or the thickness direction of the ingot. However, even when the cast ingot is pressed in an arbitrary direction, effects similar to those described above can be obtained.

In the embodiments described hereinabove, the entirety of the cast ingot is subjected to plastic working, but the ingot may be partially subjected to plastic working.

For example, the entirety of a profile cast ingot produced through unidirectional solidification casting is not necessarily subjected to plastic working, and the profile cast ingot may be partially subjected to plastic working at percent working of 25% or more. In such a case, at least a portion of the cast ingot facing a stopper is preferably subjected to plastic working at percent working of 25% or more, and the percent working of other portions of the ingot may be less than 25%.

Particularly, when a cast ingot has a large size and the intended final product also has a large size, the cast ingot may be subjected to swaging, to thereby subject a portion of the ingot facing a stopper to forging-elongation at percent working of 25% or more. When the cast ingot (i.e., material for plastic working), which assumes a complicated shape that is difficult to attain through conventional casting and which is not available, is partially deformed through forging-elongation, the cast ingot can be formed into a material having a shape similar to that of a forging die. In addition, through this partial plastic working (forging-elongation), mechanical characteristics of a portion of the material can be improved. When the partially forged and elongated material is subjected to die forging, which is the subsequent process, or mechanical processing, variation in mechanical characteristics of portions of interest of the resultant product can be prevented.

Thus, through partial plastic working, the following advantages are obtained

(1) A cast ingot fed into a forging die can be made to have a smallest possible volume.

(2) Therefore, the amount of burrs formed after forging can be minimized. Forging yield is improved as compared with the case where a blank cut from a round cast bar is used.

(3) Load imposed to forging dies can be reduced as compared with the case where a cut blank is used, and therefore the service life of the dies can be lengthened, contributing to reduction of costs.

The aforementioned plastic-worked member, particularly the plastic-worked member which has undergone plastic working at percent working of 25% or more and has no variation in mechanical characteristics, is typically employed to manufacture the below-described parts, which should not be construed as limiting the invention parts.

Examples of automobile parts for suspension and brake systems in which the plastic-worked member is employed include an upper arm, a lower arm,, a torsion rod and an ABS pump housing.

Examples of engine-related automobile parts in which the plastic-worked member is employed include a connecting rod, a GDI body and an internal combustion engine piston. Examples of motorcycle parts in which the plastic-worked member is employed include a cushion arm, a bracket and a fork bottom bridge. Examples of bicycle parts in which the plastic-worked member is employed include a gear crank.

When the aforementioned part is produced from a plastic-worked member, the entirety of a cast ingot is subjected to plastic working at percent working of 25% or more, or the cast ingot is partially subjected to plastic working such as forging or forging-elongation at percent working of 25% or more.

Industrial Applicability:

As described hereinabove, according to the present invention, a plastic-worked member is obtained by subjecting to plastic working a cast ingot produced through oriented crystal growth starting at a portion of melt in the vicinity of the cooling member toward an opposite portion of melt in the vicinity of the stopper. Therefore, mechanical characteristics associated with the portion facing the stopper, which have conventionally been unsatisfactory, can be significantly improved, and thus, the strength of plastic-worked member produced via oriented crystal growth can be improved throughout the member with reduced variation in strength.

Plastic-worked members produced through oriented crystal growth have heretofore been employed as products of high value in use, due to their excellent internal quality and small variation in size and weight. According to the present invention, strength is improved in the entirety of such a plastic-worked member and variation in strength is reduced, and thus, application of the member has been extended to a structural member requiring strength.

1. A plastic-worked member obtained using a closable mold by plastic working, at percent working equal to or higher than a predetermined level, of a cast ingot produced through unidirectional forced-cooling of molten metal teeming via a molten metal inlet, wherein the forced-cooling is performed by means of a cooling member, an end surface of a stopper for stopping up the molten metal inlet serves as a portion of the inner surface of the mold, and the cooling member serves as another portion of the inner surface of the mold.

2. A plastic-worked member according to claim 1, wherein the unidirectional forced-cooling is attained from a side of the cooling member to a side of the end surface of the stopper.

3. A plastic-worked member according to claim 1, wherein the percent working is attained through single-step plastic working.

4. A plastic-worked member according to claim 1, wherein the percent working is attained through multi-step plastic working.

5. A plastic-worked member according to any one of claims 1, 3 and 4, wherein the predetermined level is 25%.

6. A plastic-worked member according to any one of claims 1, 3 and 4, wherein the predetermined level is 50%.

7. A plastic-worked member according to any one of claims 1 and 3 through 5, wherein the plastic working is partial plastic working performed on the cast ingot.

8. A plastic-worked member according to any one of claims 1 and 3 through 6, wherein the plastic working is performed on at least a portion of the cast ingot including a portion on a side of the end surface of the stopper.

9. A plastic-worked member according to claim 1, which serves as an intermediate product.

10. A plastic-worked member according to claim 1, which serves as a final processed product.

11. A plastic-worked member according to any one of claims 1, 7 and 8, wherein the plastic working is any one of cold forging, hot forging, forging-elongation, rolling, extrusion, component rolling and rotary forging.

12. A plastic-worked member according to claim 1, wherein the metal is aluminum or aluminum alloy.

13. A plastic-worked member according to claim 1, wherein DAS of a metallographic structure as observed on a side of the end surface of the stopper is 1.1 to 10 times that on a side of the cooling member.

14. A plastic-worked member according to claim 1, wherein a grain size in terms of metallographic structure as observed on a side of the end surface of the stopper is 1.05 to 7 times that on a side of the cooling member.

15. A plastic-worked member according to claim 1, wherein, in relation to a size of grains that form a secondary phase of a plastic-worked member crystal, the grain size as observed on a side of the end surface of the stopper is at least 1.2 times that observed on a side of the cooling member.

16. A production method of a plastic-worked member comprising the steps of using a closable mold that has a molten metal inlet and a mold cavity that is partially defined by an end surface of a stopper and by a cooling member; unidirectionally forced-cooling molten metal teeming via the molten metal inlet into the mold cavity to solidify the molten metal into a cast ingot; and plastic-working the cast ingot at percent working of at least a predetermined level.

17. A production method of a plastic-worked member according to claim 16, wherein the step of unidirectionally forced-cooling the molten metal is attained from a side of the cooling member to a side of the end surface of the stopper.

18. A production method of a plastic-worked member according to claim 16, wherein the percent working is attained through single-step plastic working.

19. A production method of plastic-worked member according to claim 16, wherein the percent working is attained through multi-step plastic working.

20. A production method of a plastic-worked member according to any one of claims 16, 18 and 19, wherein the predetermined level is 25%.

21. A production method of a plastic-worked member according to any one of claims 16, 18 and 19, wherein the predetermined level is 50%.

22. A production method of a plastic-worked member according to any one of claims 16 and 18 to 20, wherein the plastic working is partial plastic working performed on the cast ingot.

23. A production method of a plastic-worked member according to any one of claims 16 and 18 through 21, wherein the plastic working is performed on at least a portion of the cast ingot including a portion on a side of the end surface of the stopper.

24. A production method of a plastic-worked member according to any one of claims 16, 22 and 23, wherein the plastic working is any one of cold forging, hot forging, forging-elongation, rolling, extrusion, component rolling, and rotary forging.
